(19) United States
(12) Patent Application Publication
(10) Pub. No.: US 2018/0044156 A1
(43) Pub. Date: Feb. 15, 2018

(54) Jar Opening Assembly

(71) Applicant: Lionel Jacobs, Costa Mesa, CA (US)

(72) Inventor: Lionel Jacobs, Costa Mesa, CA (US)

(21) Appl. No.: 15/232,981

(22) Filed: Aug. 10, 2016

(51) Int. Cl. B67B 7/14

(52) U.S. Cl. CPC B67B 7/14

(57) ABSTRACT

A jar opening assembly includes a handle that may be manipulated. The handle unit is selectively rotated in a gripping direction and a releasing direction. A gripping unit is movably coupled to the handle unit. The gripping unit grips a lid of a jar when the handle unit is rotated in the gripping direction. Thus, the lid may be removed from the jar. The gripping unit releases the lid of the jar when the handle unit is rotated in the releasing direction. Thus, the gripping unit may be removed from the jar.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to opening devices and more particularly pertains to a new opening device for removing a lid from a jar.

### BRIEF SUMMARY OF THE INVENTION

An embodiment of the disclosure meets the needs presented above by generally comprising a handle that may be manipulated. The handle unit is selectively rotated in a gripping direction and a releasing direction. A gripping unit is movably coupled to the handle unit. The gripping unit grips a lid of a jar when the handle unit is rotated in the gripping direction. Thus, the lid may be removed from the jar. The gripping unit releases the lid of the jar when the handle unit is rotated in the releasing direction. Thus, the gripping unit may be removed from the jar.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a jar opening assembly according to an embodiment of the disclosure.

FIG. 2 is a bottom perspective view of an embodiment of the disclosure.

FIG. 3 is a cross sectional view taken along line 3-3 of FIG. 1 of an embodiment of the disclosure.

FIG. 4 is a cross sectional view taken along line 4-4 of FIG. 3 of an embodiment of the disclosure.

FIG. 5 is a perspective in-use view of an embodiment of the disclosure.

### DETAILED DESCRIPTION OF THE INVENTION

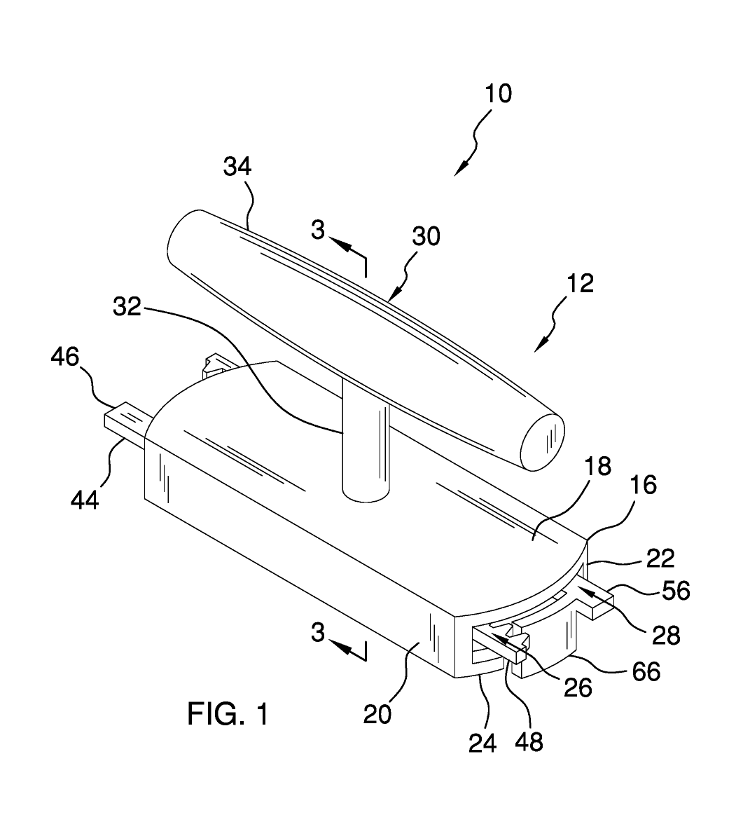

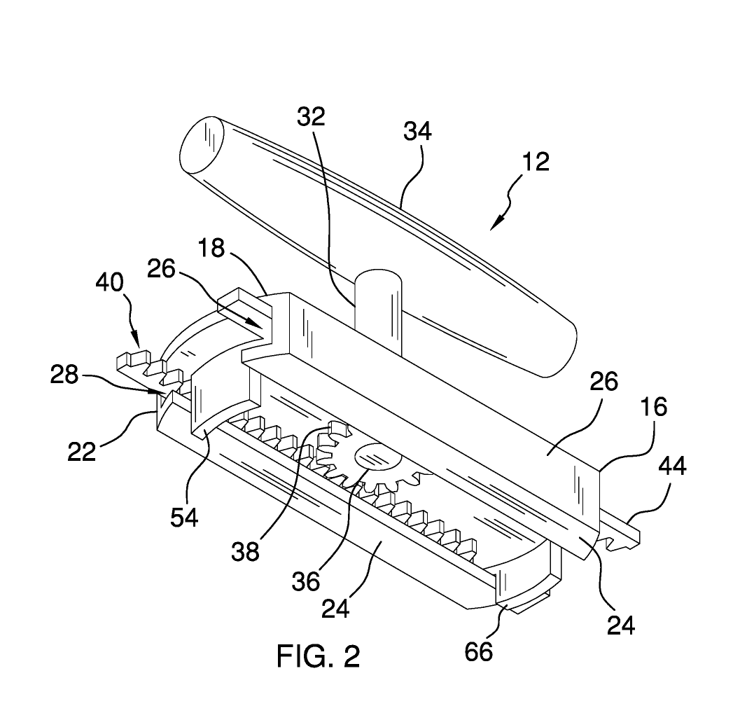

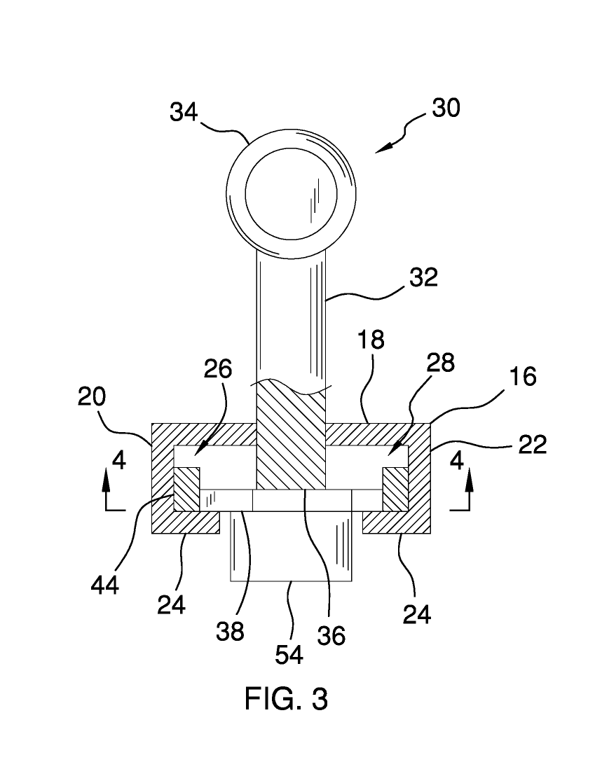

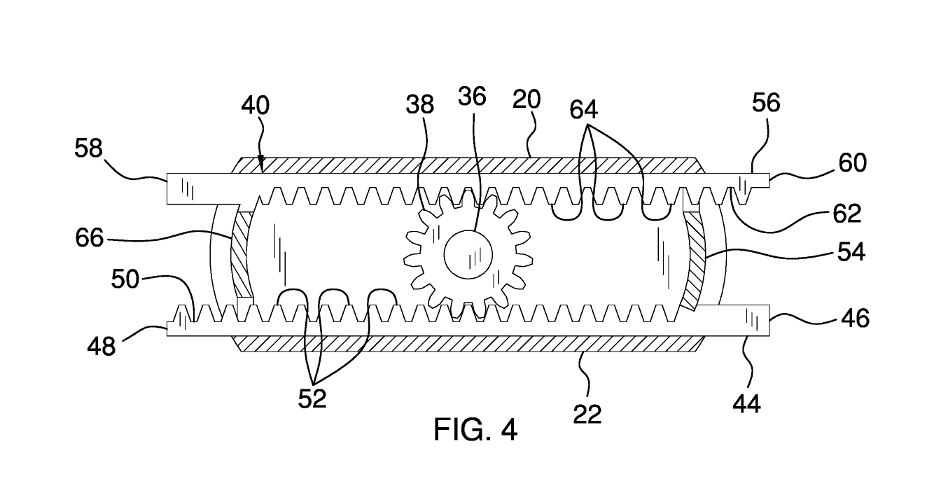

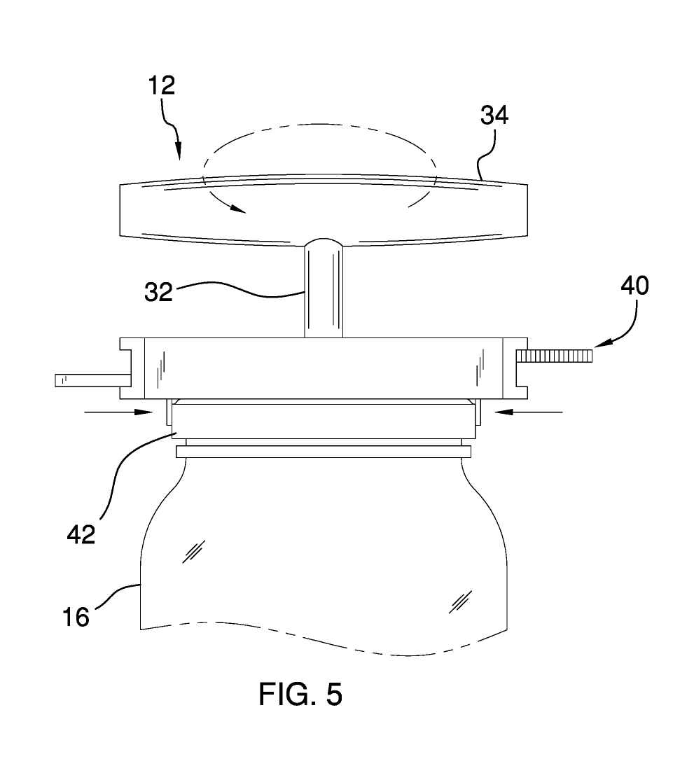

With reference now to the drawings, and in particular to FIGS. 1 through 5 thereof, a new opening device embodying the principles and concepts of an embodiment of the disclosure and generally designated by the reference numeral 10 will be described.

As best illustrated in FIGS. 1 through 5, the jar opening assembly 10 generally comprises a handle unit 12. The handle unit 12 may be manipulated to position the handle unit 12 over a jar 14. The jar 14 may be a food jar 14 or the like. The handle unit 12 is selectively rotated in a gripping direction and a releasing direction.

The handle unit 12 comprises a housing 16 that has a top wall 18, a first lateral wall 20 and a second lateral wall 22. The housing 16 includes a pair of tabs 24. Each of the tabs 24 extends inwardly from an associated one of the first lateral wall 20 and the second lateral wall 22. Each of the tabs 24 is coextensive with the associated first 20 and second 22 lateral walls. Each of the tabs 24 is spaced from the top wall 18. Thus, the tabs 24 define a first channel 26 and a second channel 28 in the housing 16.

The handle unit 12 includes a handle 30. The handle 30 has a stem 32 and a grip 34. The grip 34 is oriented transverse with respect to the stem 32. Thus, the grip 34 may be gripped thereby facilitating the handle 30 to be rotated.

The stem 32 extends through the top wall 18 of the housing 16. The stem 32 has a distal end 36 with respect to the grip 34. The handle 30 is centrally positioned on the top wall 18. A gear 38 is coupled to the distal end 36 of the stem 32. The gear 38 is positioned to extend substantially between the first channel 26 and the second channel 28.

A gripping unit 40 is provided and the gripping unit 40 is movably coupled to the handle unit 12. The gripping unit 40 grips a lid 42 of the jar 14 when the handle unit 12 is rotated in the gripping direction. Thus, the lid 42 may be removed from the jar 14. The gripping unit 40 releases the lid 42 of the jar 14 when the handle unit 12 is rotated in the releasing direction. Thus, the gripping unit 40 may be removed from the jar 14.

The gripping unit 40 comprises a first rail 44 that has a first end 46, a second end 48 and an inwardly facing surface 50. The inwardly facing surface 50 comprises a plurality of teeth 52. The teeth 52 are spaced apart from each other and are distributed between the first end 46 and the second end 48. The first rail 44 is slidably positioned in the first channel 26 and the gear 38 engages the teeth 52 on the first rail 44. Thus, the first rail 44 is urged to travel in the first channel 26 when the handle 30 is rotated.

A first stop 54 is coupled to and extends away from the inwardly facing surface 50. The first stop 54 is positioned closer to the first end 46 than the second end 48. The first stop 54 extends downwardly from the first rail 44. The first stop 54 is curved to grip the lid 42 of the jar 14 when the handle unit 12 is rotated in the gripping direction.

The gripping unit 40 comprises a second rail 56 that has a primary end 58, a secondary end 60 and an inwardly facing surface 62. The inwardly facing surface 62 corresponding to the second rail 56 comprises a plurality of teeth 64. The teeth 64 corresponding to the second rail 56 are spaced apart from each other and are distributed between the primary end 58 and the secondary end 60. The second rail 56 is slidably positioned in the second channel 28 and the gear 38 engages the teeth 52 on the second rail 56. Thus, the second rail 56 is urged to travel in the second channel 28 when the handle 30 is rotated.

A second stop 66 is coupled to and extending away from the inwardly facing surface 50 corresponding to the second rail 56. The second stop 66 is positioned closer to the primary end 58 than the secondary end 60. The second stop 66 extends downwardly from the second rail 56. The second stop 66 is curved to grip the lid 42 of the jar 14 when the handle unit 12 is rotated in the gripping direction. Each of the first stop 54 and the second stop 66 is compressed against the lid 42 of the jar 14 when the handle unit 12 is rotated in the gripping direction. Each of the first stop 54 and the second stop 66 are spaced from the lid 42 of the jar 14 when the handle unit 12 is rotated in the releasing direction.

In use, the handle 30 is gripped and the gripping unit 40 is positioned on the lid 42 of the jar 14. The handle 30 is rotated in the gripping direction. Thus, each of the first stop 54 and the second stop 66 engage the lid 42. The handle 30 is further rotated in the gripping direction and the lid 42 is unscrewed from the lid 42. The gripping unit 40 enhances gripping the lid 42 for an elderly user or other physically limited user. The handle 30 is rotated in the releasing direction to release the lid 42 from the gripping unit 40.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A jar opening assembly being configured to grip a lid of a jar thereby facilitating the lid to be removed from the jar, said assembly comprising:
a handle unit being configured to be manipulated, said handle unit being selectively rotated in a gripping direction and a releasing direction; and
a gripping unit being movably coupled to said handle unit, said gripping unit being configured to grip a lid of a jar when said handle unit is rotated in said gripping direction thereby facilitating the lid to be removed from the jar, said gripping unit being configured to release the lid of the jar when said handle unit is rotated in said releasing direction thereby facilitating said gripping unit to be removed from the jar.

2. The assembly according to claim 1, wherein said handle unit comprises a housing having a top wall, a first lateral wall and a second lateral wall, said housing including a pair of tabs, each of said tabs extending inwardly from an associated one of said first lateral wall and said second lateral wall, each of said tabs being spaced from said top wall to define a first channel and a second channel in said housing.

3. The assembly according to claim 2, further comprising a handle having a stem and a grip, said grip being oriented transverse with respect to said stem wherein said grip is configured to be gripped thereby facilitating said handle to be rotated, said stem extending through said top wall of said housing, said stem having a distal end with respect to said grip, said handle being centrally positioned on said top wall.

4. The assembly according to claim 3, further comprising a gear being coupled to said distal end of said stem, said gear being positioned to extend substantially between said first channel and said second channel.

5. The assembly according to claim 1, wherein said gripping unit comprises a first rail having a first end, a second end and an inwardly facing surface, said inwardly facing surface comprising a plurality of teeth, said teeth being spaced apart from each other and being distributed between said first end and said second end.

6. The assembly according to claim 6, wherein:
said handle unit has a first channel, a handle and a gear; and
said first rail being slidably positioned in said first channel, said gear engaging said teeth on said first rail such that said first rail is urged to travel in said first channel when said handle is rotated.

7. The assembly according to claim 6, further comprising a first stop being coupled to and extending away from said inwardly facing surface, said first stop being positioned closer to said first end than said second end, said first stop extending downwardly from said first rail, said first stop being curved wherein said first stop is configured to grip the lid of the jar when said handle unit is rotated in said gripping direction.

8. The assembly according to claim 1, wherein said gripping unit comprises a second rail having a primary end, a secondary end and an inwardly facing surface, said inwardly facing surface corresponding to said second rail comprising a plurality of teeth, said teeth corresponding to said second rail being spaced apart from each other and being distributed between said primary end and said secondary end.

9. The assembly according to claim 8, wherein:
said handle unit has a second channel, a gear and a handle; and
said second rail being slidably positioned in said second channel, said gear engaging said teeth on said second rail such that said second rail is urged to travel in said second channel when said handle is rotated.

10. The assembly according to claim 9, further comprising a second stop being coupled to and extending away from said inwardly facing surface corresponding to said second rail, said second stop being positioned closer to said primary end than said secondary end, said second stop extending downwardly from said second rail, said second stop being curved wherein said second stop is configured to grip the lid of the jar when said handle unit is rotated in said gripping direction.

11. The assembly according to claim 10, wherein:
said gripping unit includes a first stop; and
each of said first stop and said second stop being compressed against the lid of the jar when said handle unit is rotated in said gripping direction, each of said first stop and said second stop being spaced from the led of the jar when said handle unit is rotated in said releasing direction.

12. A jar opening assembly being configured to grip a lid of a jar thereby facilitating the lid to be removed from the jar, said assembly comprising:
a handle unit being configured to be manipulated, said handle unit being selectively rotated in a gripping direction and a releasing direction, said handle unit comprising:
a housing having a top wall, a first lateral wall and a second lateral wall, said housing including a pair of tabs, each of said tabs extending inwardly from an associated one of said first lateral wall and said second lateral wall, each of said tabs being spaced from said top wall to define a first channel and a second channel in said housing,
a handle having a stem and a grip, said grip being oriented transverse with respect to said stem wherein said grip is configured to be gripped thereby facilitating said handle to be rotated, said stem extending through said top wall of said housing, said stem having a distal end with respect to said grip, said handle being centrally positioned on said top wall, and
a gear being coupled to said distal end of said stem, said gear being positioned to extend substantially between said first channel and said second channel; and
a gripping unit being movably coupled to said handle unit, said gripping unit being configured to grip a lid of a jar when said handle unit is rotated in said gripping direction thereby facilitating the lid to be removed from the jar, said gripping unit being configured to release the lid of the jar when said handle unit is rotated in said releasing direction thereby facilitating said gripping unit to be removed from the jar, said gripping unit comprising:
a first rail having a first end, a second end and an inwardly facing surface, said inwardly facing surface comprising a plurality of teeth, said teeth being spaced apart from each other and being distributed between said first end and said second end, said first rail being slidably positioned in said first channel, said gear engaging said teeth on said first rail such that said first rail is urged to travel in said first channel when said handle is rotated,
a first stop being coupled to and extending away from said inwardly facing surface, said first stop being positioned closer to said first end than said second end, said first stop extending downwardly from said first rail, said first stop being curved wherein said first stop is configured to grip the lid of the jar when said handle unit is rotated in said gripping direction,
a second rail having a primary end, a secondary end and an inwardly facing surface, said inwardly facing surface corresponding to said second rail comprising a plurality of teeth, said teeth corresponding to said second rail being spaced apart from each other and being distributed between said primary end and said secondary end, said second rail being slidably positioned in said second channel, said gear engaging said teeth on said second rail such that said second rail is urged to travel in said second channel when said handle is rotated,
a second stop being coupled to and extending away from said inwardly facing surface corresponding to said second rail, said second stop being positioned closer to said primary end than said secondary end, said second stop extending downwardly from said second rail, said second stop being curved wherein said second stop is configured to grip the lid of the jar when said handle unit is rotated in said gripping direction, each of said first stop and said second stop being compressed against the lid of the jar when said handle unit is rotated in said gripping direction, each of said first stop and said second stop being spaced from the led of the jar when said handle unit is rotated in said releasing direction.
